(19) United States
(12) Patent Application Publication
(10) Pub. No.: US 2019/0190182 A1
(43) Pub. Date: Jun. 20, 2019

(54) Zero Insertion Force Power Connector

(71) Applicant: Satyajit Patwardhan, Fremont, CA (US)

(72) Inventor: Satyajit Patwardhan, Fremont, CA (US)

(73) Assignee: ConnectMyEV Inc., Fremont, CA (US)

(21) Appl. No.: 15/844,555

(22) Filed: Dec. 17, 2017

(51) Int. Cl. H01R 13/193

(52) U.S. Cl. CPC H01R 13/193

(57) ABSTRACT

The invention teaches a zero-insertion force socket connector that allows mating with a standard pin connector with zero insertion force. An actuation mechanism built into the socket connector is actuated after mating to create a high level of contact force necessary to establish a good electrical contact. The novel method for socket actuation is designed such that the socket contact does not exert any compression force on its mating pin contact—as is the case for a typical pin & socket joint. This helps eliminate buckling of slender contact pins when large contact force is required. The novel socket design allows it to work with a standard pin contact, which could be defined as a standard required connector provided on—for example, on every electric vehicle. Thus, the invention allows connecting to an existing or standard electric vehicle without any modification, yet it allows for zero insertion force, delivers the high contact force and preserves the long-term integrity of the connector pins by eliminating pin buckling.

### FIELD OF THE INVENTION AND PRIOR ART RELATED TO THE INVENTION

The field of invention is zero-insertion-force electrical connectors. Traditionally, zero insertion force contacts are used for inserting microchips with delicate pins into an electrical circuit. The power level involved in this connection is very low. The typically is the ease of insertion without deforming the pins and then subsequently making sure each individual pin is securely connected to its mating contact. There are several designs proposed to address this field of technology. However, at the other end of the power spectrum i.e. for very high power connectors, there are no zero insertion force designs proposed. This is mainly because thus far the high power connections were typically not detachable connections. However with the advent of modern EVs this is changing. An EV charging connector is by definition a detachable connector that has to carry 50, 100 or 400 amperes. It also needs to be operable by all types of drivers, including a frail individual and yet guarantee a high quality electrical connection. One additional requirement—mostly driven by the way the EV market has evolved, is that any charging connector is required to work with standard charging port without any modification the existing charge port. This invention teaches such a connector, which is capable mating with zero insertion force with a standard pin, is able to create a very high contact force, does not create any pushback or recoil to the person or robot handling the connector and in the process, completely eliminates the compressive force exerted on the pin—which is typical for a traditional pin-and-socket joint; thus, eliminating the bending or buckling of slender connector pins.

### BRIEF DESCRIPTION OF DRAWINGS

FIG. 1: A connector with pin and socket contacts that is typical in prior art. Shown here in disengaged position.

FIG. 2: A connector with pin and socket contacts that is typical in prior art. Shown here in engaged position. The forces encountered by the pin and the socket during engagement process are also shown in detail.

FIG. 3 Construction details of one embodiment of this invention showing the modified socket-side connector that can mate with unmodified pin-side connector.

FIG. 4 Step 1 of engagement process of the two connector halves.

FIG. 5 Step 2 of engagement process of the two connector halves.

FIG. 6 Step 3 of engagement process of the two connector halves.

### DETAILED DESCRIPTION OF THE INVENTION

An electrical power connector has two halves, each carrying a group of connectors. These connector halves are brought together to mate with each other in a particular relative orientation. Frequently, the connectors have mechanical guides on one or both halves to guide the mating process into correct orientation such that each of the contacts from the first half mates with its matching counterpart from the second half. Furthermore, if the contact pairs are pin-and-socket type, then an insertion force is required while mating the connector halves. This insertion force is required to push the pins into its mating socket against the opposing friction force created by the socket's grip on the pin. The sliding of pin with respect to socket in the presence of a strong contact force is an important requirement for establishing good quality contact. As a side effect, this insertion force acts to create compressive stress in the pin and if the pin-and-socket is misaligned, or if the required insertion force is large, the pin may experience buckling or similar distortion. This invention teaches a contactor that needs zero insertion force, but when a mechanism on the connector is actuated, it creates large contact forces and orchestrates sliding of pin with respect to socket while maintaining the contact force. Furthermore, the clever design of the actuation mechanism eliminates compressive stress on the pin and converts it to tensile stress, thus eliminating the possibility of buckling distortion even when the friction and contact forces between pin and socket are high.

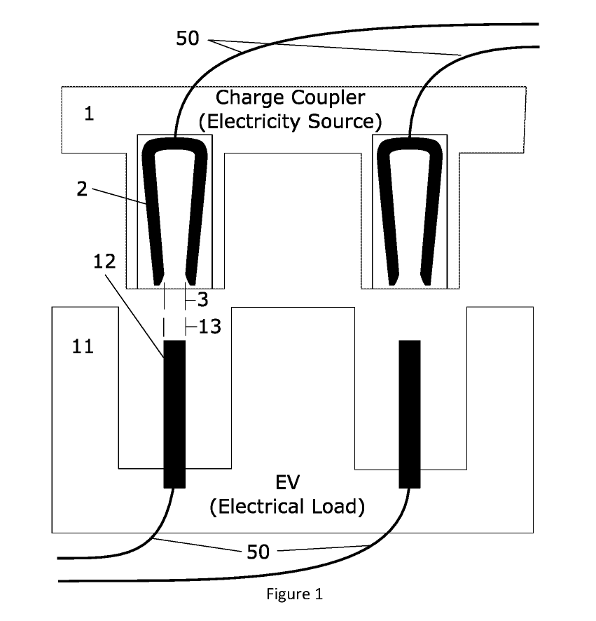

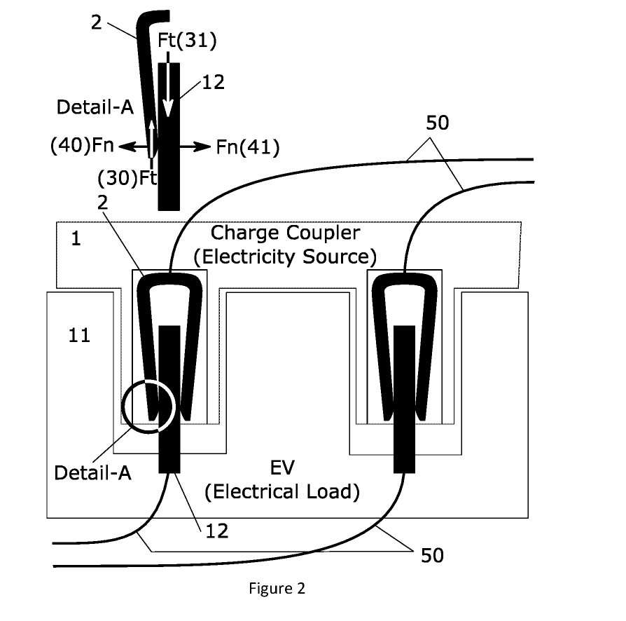

The arrangement: A basic design of a traditional pin and socket connector commonly found in prior art is shown in FIG. 1 and FIG. 2. The FIG. 1 shows two halves 1 and 11 of connector in disconnected position and FIG. 2 shows the two halves of the connector in their mated position. The important parts of the connector assembly are: Socket-side connector half 1, Pin-side connector half 11, the socket contact 2 and the pin contact 12. The wires 50 connect the source and drain of the electricity to socket 2 and pin 12 of the connector. From the safety viewpoint, the socket is typically connected to the source of the electricity and pin to the drain of electricity. FIG. 2 also shows the force marked 30 of magnitude Ft and acting on socket, force marked 40 of magnitude Fn and acting on socket, force marked 31 of magnitude Ft and acting on the pin, force marked 41 of magnitude Fn and acting on pin. As seen in FIG. 1, the dimension of opening of socket (3) is slightly smaller than dimension (13) of the pin. This makes the socket to expand slightly during engagement and create force Fn. Also due to friction across socket-pin interface, force Ft is generated, which resists the insertion of pin into the socket. This force Ft is the insertion force. It should be noted that when Fn increases, Ft also increases. The quality of electrical connection improves i.e. the contact resistance decreases when Fn increases. Hence it is desirable to increase Fn, but as a result, insertion force Ft also increases. It is easy to see that in the traditional pin-and-socket connector of FIG. 1 and FIG. 2, Ft's action on the pin (12) is in the direction of compressing the pin 12.

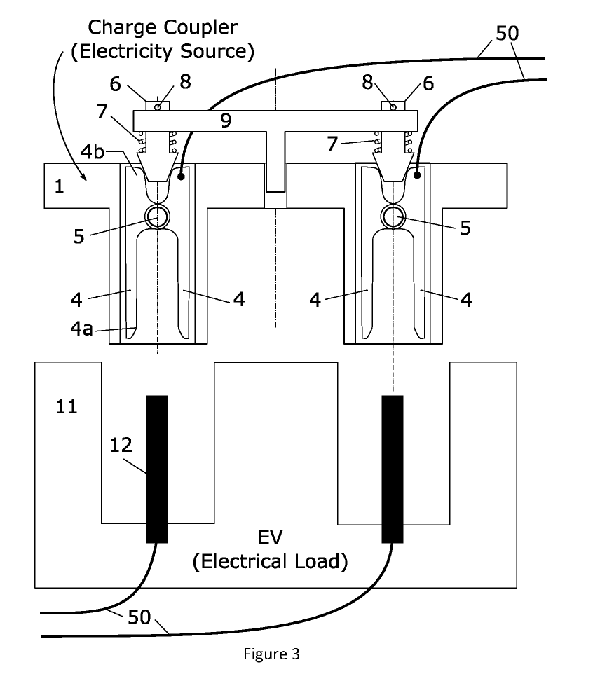

FIG. 3 shows one embodiment of the invention. This invention teaches a modified socket-side connector half as shown in FIG. 3. As seen in FIG. 3, the pin-side connector half is intentionally left unchanged, so that the invention can be applied to mate with corresponding, unmodified pin connector. The socket side connector half starts with connector body 1. The socket is split into a plurality of pieces 4 that are attached to body 1 through the hinge 5. A plunger 6 is carried by a push plate 9 and is loaded by a spring 7 which is kept in compression using the pin 8. Electrical wires 50 are connected to the split socket pieces.

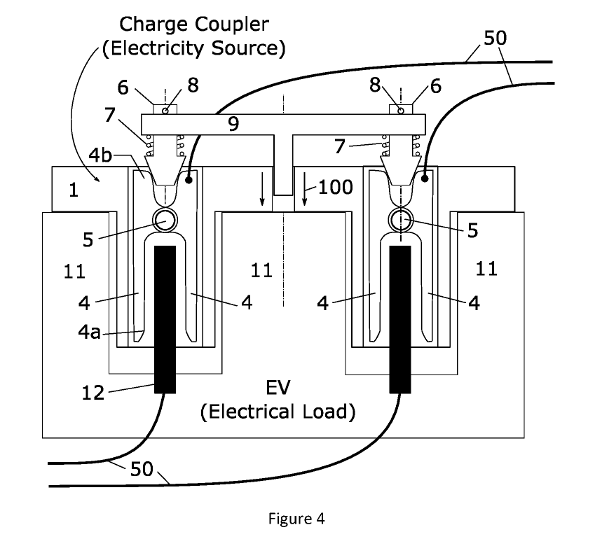

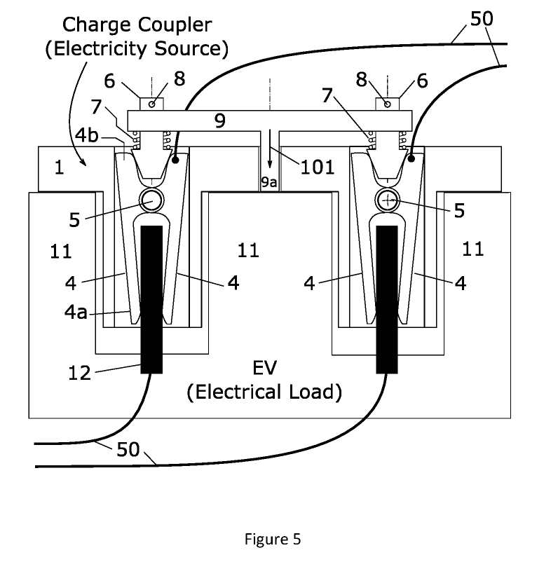

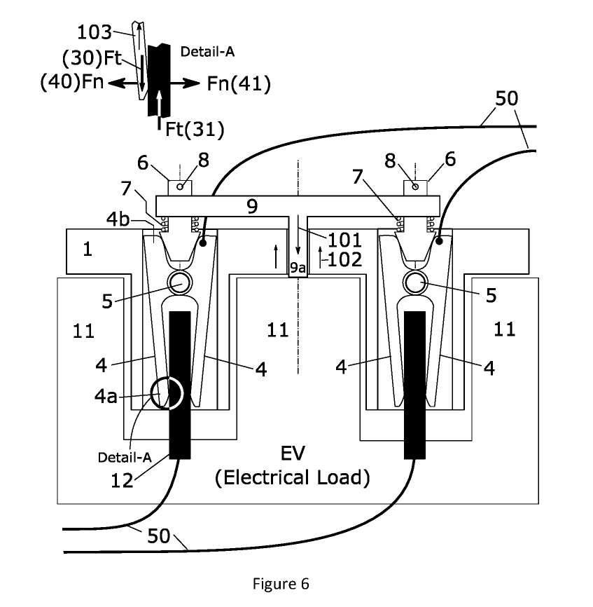

Operation: FIG. 3 to FIG. 6 show the operating sequence for one embodiment of the invention. FIG. 3 shows the two connector halves in disengaged state. FIG. 4 shows the first step of engagement where the body 1 of socket-side connector half is moved (see motion arrows 100), to mate with pin-side half. In this motion, the body 1, push plate 9, plunger 7, spring 7 and retaining pin 8; all move together as one piece. FIG. 5 shows the next step where the push plate 9 is moved with respect to body 1 (see motion arrows 101) until the protrusion 9a of the push plate 9 reaches the body 11 of pin side half. By this action the plunger 6 is also pushed into one end of the socket pieces 4, thus forcing their other end to clamp around the pin 12. Notice that a predetermined force produced by the spring 7, which pushes the plunger 6 into socket pieces 4 and in turn the socket pieces 4 also exert a predetermined clamping or contact force on pin 12. FIG. 6 shows the next step when the push plate 9 is moved further with respect to the body 1 (see motion arrows 101). As the protrusion 9a pushes on pin-side body 11, it causes the body 1 to move away from pin-side half's body 11 (see motion arrows 102). In the process the socket pieces 4 that are already exerting contact force on the pins; slide with respect to the pin. Note that the sliding is such that the pins are in tension as opposed to compression as is the case of traditional pin and socket connection. FIG. 6 also shows the forces: force marked 30 of magnitude Ft and acting on socket, force marked 40 of magnitude Fn and acting on socket, force marked 31 of magnitude Ft and acting on the pin, force marked 41 of magnitude Fn and acting on pin. As described earlier, the force Fn is a direct result of the force exerted by the plunger 6 on sockets pieces 4, which in turn is a direct result of force created by spring 7. Also, the direction for force marked 31 is such that it puts the pin in tension, thus eliminating any buckling distortion. In a traditional pin and socket connection shown in FIG. 1, when the socket wears out, the dimension 3 increases and the socket no longer has to expand as much as when the contacts were new. As a result, the contact force Fn starts to diminish and consequently the contact resistance starts to creep up. However, the invention described in FIG. 6 continues to create consistent contact force Fn even in the presence of contact wear because contact force Fn is controlled by spring 7, which compensates for the wear.

Advantages: (i) Zero Insertion Force: during the act of mating (see FIG. 4, motion 100), the force required to move socket-side connector half is negligible since the socket pieces 4 are wide open and allow free relative motion between pin and socket, (ii) Lighter Robot Design: if the two connector halves are brought together by a robot, the elimination of insertion force allows a lighter robot design. Furthermore, when the connector is actuated, the generated force is between two internal components (1 and 9 of FIG. 5 FIG. 6) of socket half of the connector and subsequently between the socket-side half and pin-side half of the connector (FIG. 6). This actuation force never gets transmitted back to the robot arm orchestrating the mating. (iii) Consistent Contact Force: Since the contact force Fn (see FIG. 6) is controlled by an independent spring 7, a consistent contact force is generated even after contact wear. (iv) No Buckling: The sliding between the pin and the socket happens in the direction of pull (see FIG. 6, motion 103) and thus eliminates the possibility of any buckling of pins.

Application: One of the important application of this technology is in the field of robotic hands-free charging of electric vehicles (EVs). In this application, a robot end effector would be fitted with one half of an EV charging connector (typically the socket-side half), and the other half would be installed on the electric vehicle. When the EV is to be charged, the robot would move its end effector and the attached connector half to bring it to mate with the connector half mounted on the EV. If this connector is to be designed as described in this invention, the Robot design can be light. Or phrased differently, a same robot can extend itself to its most overstretched configuration and yet be able to perform the insertion task since the insertion forces are zero. Furthermore, the connectors will deliver consistent and high contact forces that won't degrade over time and eliminate pin deformation. Due to zero insertion force and extra opening offered by the socket contacts as well elimination of pin deformation tendencies, the robot arm may have slightly extra leeway in alignment. cm What is claimed is:

1 a. a connector with a first half and a second half, constrained to mate each other along a predefined axis and a predefined orientation,
b. a first group of n pin type connectors attached to the first half of the connector,
c. n groups of blades with m of blades in each group and movably mounted on second half with each group positioned to have its blades surround each of the n pin type connectors when the two connector halves mate along the predefined axis and in predefined orientation,
d. with each of the m blades in each group of blades having a first and a second end, such that the second end can exert a normal force on one of the pin type connectors from the first group of n pin type connectors, when the second end is moved with respect to the second connector half,
e. a first group of n springs, with each spring having a first end and second end,
f. a first push plate capable of moving with respect to the second half of the connector, and in contact with the first end of all springs from the first group of n springs,
g. a group of n mechanical linkages, with each linkage having an input and m outputs,
h. with the second end of each spring from the first group of n springs attached to the inputs of each of the mechanical linkages from the first group of n mechanical linkages,
i. with, each of the m outputs of each of the mechanical linkages from the first group of n mechanical linkages connected to the second end of each of the m blades from each of the groups of n blades,
j. with the first push plate having a first protrusion, capable of pushing against the first half of the connector after the first push plate has travelled a predefined distance with respect to the second half of the connector and force the second half of the connector move away from the first half of the connector.
